(19) United States
(12) Patent Application Publication
(10) Pub. No.: US 2025/0200721 A1
(43) Pub. Date: Jun. 19, 2025

(54) TRAINING METHOD, TRAINING APPARATUS, IMAGE PROCESSING METHOD, METHOD OF GENERATING LEARNED MODEL, AND STORAGE MEDIUM

(71) Applicant: CANON KABUSHIKI KAISHA, Tokyo (JP)

(72) Inventor: Yoshinori KIMURA, Tochigi (JP)

(21) Appl. No.: 18/950,295

(22) Filed: Nov. 18, 2024

(30) Foreign Application Priority Data
Dec. 13, 2023 (JP) 2023-209778

(51) Int. Cl. G06T 5/60; G06T 3/4007; G06T 5/50; G06T 5/73

(52) U.S. Cl. CPC G06T 5/60; G06T 3/4007; G06T 5/50; G06T 5/73; G06T 2207/20081; G06T 2207/20084

(57) ABSTRACT

A training method includes the steps of acquiring a first training image and a second training image corresponding to the first training image, having a higher resolution than the first training image, generating a third training image by enlarging the first training image by interpolation, generating a fourth training image with different sharpness for each region based on the second training image, the third training image, and at least one of a first region having a luminance value which is equal to or larger than a predetermined value and a second region having a luminance change rate which is equal to or larger than a predetermined rate in the first training image, and training a machine learning model based on the first training image and the fourth training image.

### BACKGROUND

### Technical Field

One aspect of this embodiment relates to a training method, a training apparatus, an image processing method, a method of generating a learned model, and a storage medium.

### Description of Related Art

Japanese Patent Laid-open No. 2021-140758 discloses a method of correcting blurred images caused by aberration and diffraction of an optical system using a DL (Deep Learning) model. U.S. Pat. No. 11,403,485 discloses a method of colorizing monochrome images using a DL model.

The methods disclosed in Japanese Patent Laid-open No. 2021-140758 and U.S. Pat. No. 11,403,485 cannot perform upscaling with different sharpness for each region of the image using the DL model.

### SUMMARY

A training method according to one aspect of the disclosure includes the steps of acquiring a first training image and a second training image corresponding to the first training image, having a higher resolution than the first training image, generating a third training image by enlarging the first training image by interpolation, generating a fourth training image with different sharpness for each region based on the second training image, the third training image, and at least one of a first region having a luminance value which is equal to or larger than a predetermined value and a second region having a luminance change rate which is equal to or larger than a predetermined rate in the first training image, and training a machine learning model based on the first training image and the fourth training image.

Further features of various embodiments of the disclosure will become apparent from the following description of exemplary embodiments with reference to the attached drawings.

### BRIEF DESCRIPTION OF THE DRAWINGS

FIG. 1 is a diagram illustrating a flow of learning a convolutional neural network in a first embodiment.

FIG. 2 is a block diagram of an image processing system in a first embodiment.

FIG. 3 is an external view of the image processing system in the first embodiment.

FIG. 4 is a flowchart of learning the convolutional neural network in the first embodiment.

FIG. 5 is a flowchart of generating an output image using the convolutional neural network in the first embodiment.

FIG. 6 is a block diagram of an image processing system in a second embodiment.

FIG. 7 is an external view of the image processing system in the second embodiment.

FIG. 8 is a block diagram of an image processing system in a third embodiment.

FIG. 9 is a flowchart of generating an output image using a convolutional neural network in the third embodiment.

FIG. 10 is a diagram describing an overview of this disclosure.

### DETAILED DESCRIPTION

In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or programs that, when executed by the CPU, cause the CPU to perform operations corresponding to units or functions. In the hardware context, the term “unit” refers to a hardware element, a circuit, an assembly, a physical structure, a system, a module, or a subsystem. Depending on the specific embodiment, the term “unit” may include mechanical, optical, or electrical components, or any combination of them. The term “unit” may include active (e.g., transistors) or passive (e.g., capacitor) components. The term “unit” may include semiconductor devices having a substrate and other layers of materials having various concentrations of conductivity. It may include a CPU or a programmable processor that can execute a program stored in a memory to perform specified functions. The term “unit” may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials.

Referring now to the accompanying drawings, a detailed description will be given of embodiments according to the disclosure. Corresponding elements in respective figures will be designated by the same reference numerals, and a duplicate description thereof will be omitted.

First, the summary of each embodiment will be described before each embodiment is specifically described. Each embodiment uses a DL (Deep Learning) model (machine learning model) to upscale the image with different sharpness (amount of high-frequency component included) for each region (partial region). Upscaling is an image enlargement process that generates a sharp and high-resolution image with a large number of pixels, in which a high-frequency component that cannot be represented in a low-resolution image with a small number of pixels are estimated.

Image processing by the DL uses the convolutional neural network as a machine learning model. The convolutional neural network uses a filter (or kernel) that is convolved with an image, a bias that is added, and an activation function that performs nonlinear transformation. The values of filter and bias are called a weight and are generated by training with training images. For example, in the case of DL upscaling, a low-resolution image with few pixels and a corresponding sharp high-resolution image with many pixels are used as training images. Since the purpose of each embodiment is to enlarge an image captured by a camera with DL upscaling, the low-resolution image among the training images is equivalent to an image captured by the camera.

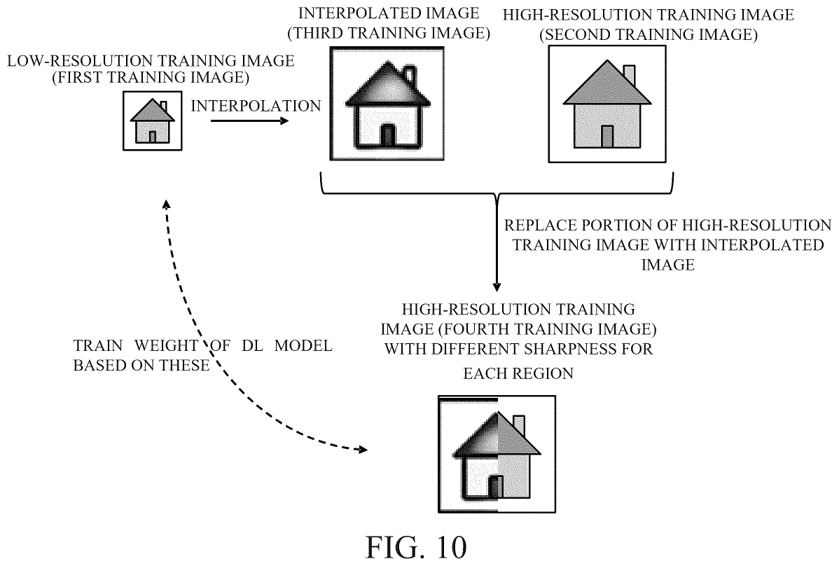

Next, referring to FIG. 10, an overview of each embodiment will be described. In each embodiment, first, a low-resolution training image (first training image with low resolution) and a corresponding high-resolution training image (second training image with high resolution) are acquired. Here, the low-resolution training image is equivalent to an image captured by the camera, and the high-resolution training image is a sharp image (correct image) as a target of the upscaled image output by the DL model by inputting the low-resolution training image.

Next, the low-resolution training image is enlarged by interpolation to generate an interpolated image (third training image) that has the same number of pixels as the high-resolution training image. Here, the interpolated image is blurrier than the high-resolution training image because the image cannot be enlarged by interpolation to create a high-frequency component. In other words, the interpolated image is more blurred than the high-resolution training image. The number of pixels of the interpolated image is not limited to the same as that of the high-resolution training image, and may be substantially the same as the number of pixels of the interpolated image. For example, the ratio of the number of pixels of the interpolated image to the high-resolution training image may be 0.9 or more and 1.1 or less.

Next, an image (fourth training image) is generated by replacing a portion of the high-resolution training image with a corresponding portion of the interpolated image. Here, the portion of the image to be replaced is the portion corresponding to a high-luminance region (where pixels have high intensity value, or bright region in short) of the low-resolution training image, and the determination of the high-luminance region is made by comparing a threshold value (predetermined value) and a luminance value (pixel intensity value, or brightness). For example, if the luminance value ranges from 0 to 255, a region with a luminance value equal to or larger than the threshold value of 220 is considered to be the high-luminance region (a first region). This can obtain a high-resolution training image (a new correct image) with different sharpness for each region. In other words, a new correct image is obtained, consisting of a blurred interpolated image in some regions and a sharp and high-resolution training image in other regions.

Finally, the weight of the DL model is learned (trained) based on the low-resolution training image and the high-resolution training image (a new correct image) with different sharpness for each region. The details of learning (training) will be described below, and the procedure of learning in this embodiment to input the low-resolution training image and generate the weight so that a loss (or error) between the upscaled image output by the DL model and the high-resolution training image with different sharpness for each region is reduced (or minimized).

Each embodiment features the high-resolution training image with different sharpness for each region, which is used for learning (training) as a new correct image. This allows DL upscaling with different sharpness for each region of the image by using the learned weight. For example, using the weight described in the summary of each embodiment, an upscaled image can be obtained with a blurred effect similar to an interpolated image in a region corresponding to the high-luminance region of the low-resolution capture image and a sharp effect similar to the correct image in other regions.

As in the conventional arts, an upscaled image with the same effect can be obtained by post-processing, such as replacing the high-luminance region with the interpolated image after DL upscaling. However, the image size of the upscaled image is large, and the post-processing is time-consuming on an edge device with low computing power. Therefore, it is required to upscale the image with different sharpness for each region of the image by only using the DL model without the post-processing as in each embodiment.

The aforementioned image processing method is an example, and this disclosure is not limited to it. Details of other image processing methods will be described in the following embodiments.

### First Embodiment

First, an image processing system in a first embodiment of this disclosure will be described. In this embodiment, the image processing system is made to perform image processing to generate an upscaled image with different sharpness for each region from a low-resolution image using a DL model obtained by training.

In the image processing using the DL model, a filter (or kernel) is convolved with an input image, a bias is added, and a nonlinear transformation is repeatedly applied to obtain an output image with a desired effect. In this embodiment, a convolutional neural network with a weight including a filter and a bias is used as the DL model.

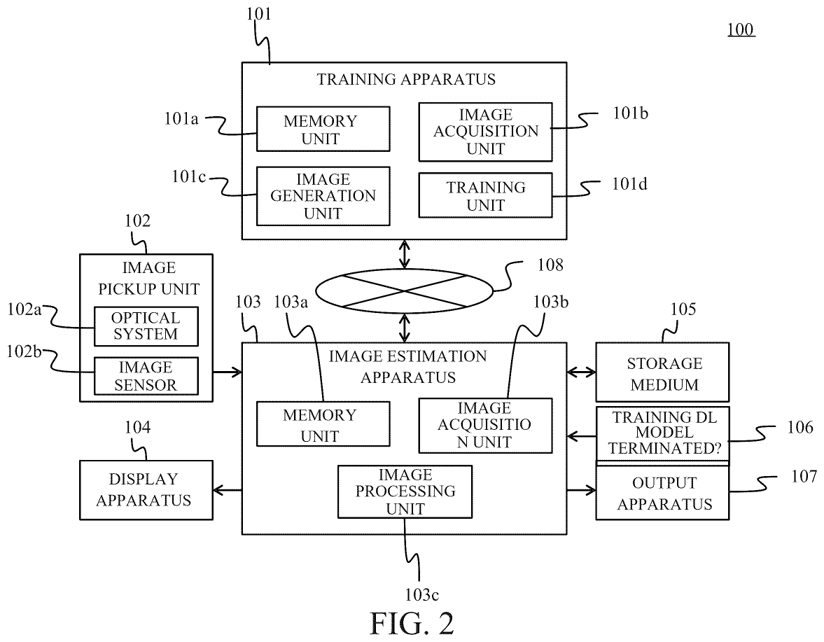

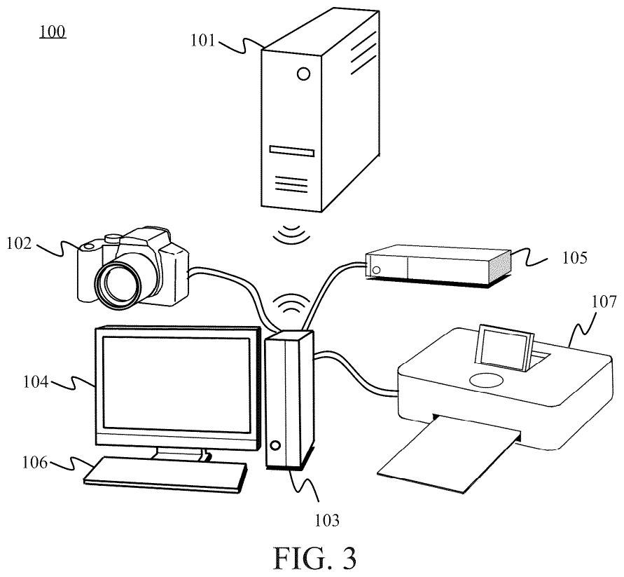

FIG. 2 is a block diagram of an image processing system 100 in this embodiment. FIG. 3 is an external view of the image processing system 100. The image processing system 100 includes a training apparatus 101, an image pickup apparatus 102, an image estimation apparatus 103, a display apparatus 104, a storage medium 105, an input apparatus 106, an output apparatus 107, and a network 108.

The training apparatus 101 includes a memory unit 101a, an image acquisition unit 101b, an image generation unit (a first image generation unit and a second image generation unit) 101c, and a training unit 101d.

The image pickup apparatus 102 includes an optical system 102a and an image sensor 102b. The optical system 102a focuses light incident on the image pickup apparatus 102 from an object space. The image sensor 102b receives an optical image of the object formed through the optical system 102a and acquires a captured image (low-resolution image). The image sensor 102b is a CCD (Charge Coupled Device) sensor or CMOS (Complementary Metal-Oxide Semiconductor) sensor, etc.

Information on an imaging condition of the captured image (a pixel pitch of the image sensor 102b, a type of an optical low-pass filter, or an ISO sensitivity, etc.) can be acquired together with the image. A development condition of the captured image (noise reduction intensity, sharpness intensity, or image compression ratio, etc.) can also be acquired together with the image. The image information acquired together with the image can be sent together with the image to the image acquisition unit 103b of the image estimation apparatus 103 described below. A memory unit that stores the acquired image, a display unit that displays the image, a transmission unit that sends the image to an external apparatus, and an output unit that stores the image in an external storage medium are not illustrated in the drawing. A control unit that controls each unit of the image pickup apparatus 102 is also not illustrated.

The image estimation apparatus 103 has a memory unit 103a, an image acquisition unit 103b, and an image processing unit (estimation unit) 103c. The image estimation apparatus 103 performs image processing to generate a high-resolution image (output) that is upscaled by the image processing unit 103c from a low-resolution image (captured image) acquired by the image acquisition unit 103b. The low-resolution image may be an image captured by the image pickup apparatus 102 or an image stored in the storage medium 105.

The DL model is used for the image processing, and information on the weight (weight information) is read (or loaded) from the memory unit 103a. The weight is learned (generated) by the training apparatus 101, and the image estimation apparatus 103 reads the weight information from the memory unit 101a via the network 108 in advance and stores it in the memory unit 103a. The weight information is stored in the memory unit 103a. The stored weight information may be a numeric value of the weight itself or in encoded form.

The upscaled image is output to at least one of the display apparatus 104, the storage medium 105, and the output apparatus 107. For example, the display apparatus 104 is a liquid crystal display (LCD) or a projector. A user can check the image being processed through the display apparatus 104 and perform image editing, etc. through the input apparatus 106. The storage medium 105 is, for example, a semiconductor memory, a hard disk, or a server on a network, etc. The input apparatus 106 is, for example, a keyboard or a mouse. The output apparatus 107 is, for example, a printer.

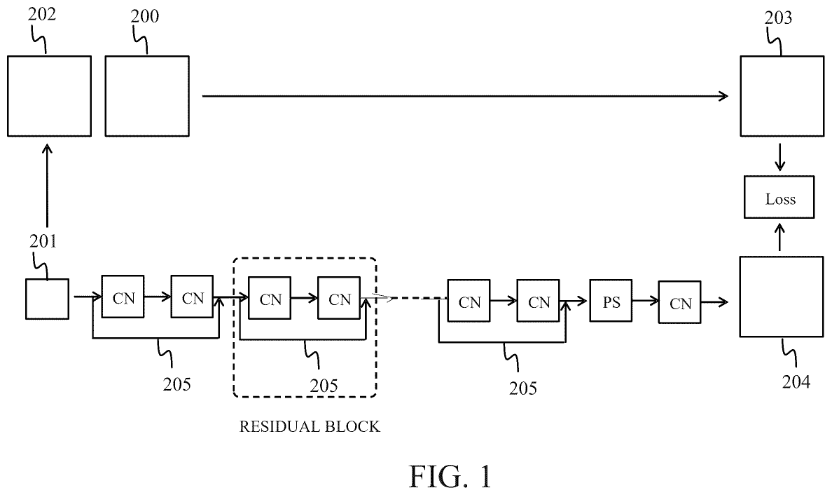

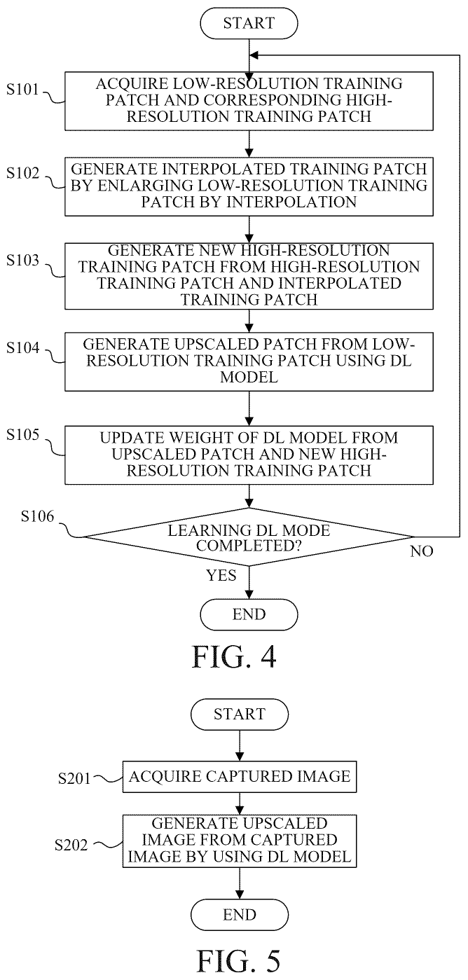

Next, referring to FIG. 1 and FIG. 4, a method of learning (training) the weight (method of generating a learned model) performed by the training apparatus 101 in this embodiment. FIG. 1 illustrates a flow of learning the weight for the DL model. FIG. 4 is a flowchart of learning the weight. Each step in FIG. 4 is mainly executed by the image acquisition unit 101b, the image generation unit 101c, or training unit 101d.

First, in step S101, the image acquisition unit 101b acquires a low-resolution training patch (first training image) 201 and a high-resolution training patch (second training image or correct image) 200 corresponding to the low-resolution training patch. The signs 200 and 201 for the patches correspond to FIG. 1. In this embodiment, the patch is a small or partial image with a predetermined number of pixels. For example, the low-resolution training patch is 128×128×3 pixels, the corresponding high-resolution training patch is 256×256×3 pixels, etc. In this case, the upscaling factor is twice as large (magnified by four times in terms of number of pixels) since the size of the height and width of the high-resolution training patch 200 is twice the size of the low-resolution training patch 201. The upscaling factor is not limited to 2×, but may be any other factor as long as the low-resolution training patch and the corresponding high-resolution training patch can be obtained.

In this embodiment, each of the low-resolution training patch and the high-resolution training patch is a three-channel color image with RGB information, but they are not limited to this. For example, each of the low-resolution training patch and the high-resolution training patch may be a one-channel monochrome image with luminance information. The low-resolution training patch and the corresponding high-resolution training patch are captured images with different resolutions (number of pixels) from each other including the same object in the same scene. Such a pair of images may be obtained by capturing the same object in the same scene using an optical system with a different focal length and cropping the corresponding parts of the two images obtained. The first training image and the second training image are not limited to the captured images, but may be generated by image processing (numerical simulation) of images corresponding to the captured images. In other words, the second training image can be an image that includes the same object in the same scene as the first training image.

Alternatively, the low-resolution training patch corresponding to the patch acquired by the image pickup apparatus 102 and the corresponding high-resolution training patch, which is less affected by blurring (aberration and diffraction) caused by the optical system 102a, may be generated by numerical simulation. In this embodiment, the low-resolution training patch and the corresponding high-resolution training patch are each generated by numerical simulation, but this embodiment is not limited to this. As described below, the high-resolution training patch is the image corresponding to the correct image, which is the target of the upscaled patch output by the DL model with the low-resolution training patch input. Therefore, the high-resolution training patch is rich in high-frequency components (that is, sharp).

Subsequently, in step S102, the image generation unit (first image generation unit) 101c generates an interpolated training patch (third training image) 202 by enlarging the low-resolution training patch (first training image) 201 by interpolation to the same number of pixels as the high-resolution training patch (second training image) 200. In this embodiment, bicubic interpolation is used as the interpolation method, but it is not limited to this. Other methods such as nearest neighbor interpolation or bilinear interpolation may be used as the interpolation method. Because the interpolation cannot create a high-frequency component in the image when it is enlarged by interpolation, the interpolated training patch is blurred (less sharp) than the high-resolution training patch. The interpolated training patch is not limited to having the same number of pixels as the high-resolution training patch, but can have substantially the same number of pixels. For example, the ratio of the number of pixels of the interpolated training patch to the high-resolution training patch may be 0.9 or more and 1.1 or less.

Subsequently, in step S103, the image generation unit (second image generation unit) 101c generates a new high-resolution training patch (fourth training image, or new correct image) 203 with different sharpness for each region based on the high-resolution training patch 200 and the interpolated training patch 202. In this embodiment, the image generation unit 101c generates the new high-resolution training patch 203 with different sharpness for each region from the high-resolution training patch 200 and the interpolated training patch 202 based on a luminance region (high-luminance region) having a predetermined value in the low-resolution training patch.

In this embodiment, the new high-resolution training patch 203 is generated by replacing the portion (corresponding portion) of the high-resolution training patch 200 that corresponds to the high-luminance region of the low-resolution training patch (first training image) 201 with the interpolated training patch 202. The determination of the high-luminance region of the low-resolution training patch 201 is performed by comparing the threshold value with the luminance value. For example, if the luminance value of the image takes the range of 0 to 255, a region of the image that takes the luminance value of 220 or more than the threshold value may be considered to be the high-luminance region. Instead of replacing a part of the high-resolution training patch 200 with the interpolated training patch 202, the new high-resolution training patch 203 may be generated by weighted averaging the two.

In this embodiment, the new high-resolution training patch 203 is generated based on the portion of the low-resolution training patch 201 corresponding to the high-luminance region, by using the high-resolution training patch 200 and the interpolated training patch 202, but is not limited to this. Other methods will be described in other embodiments.

Subsequently, in step S104, the training unit 101d inputs the low-resolution training patch (first training image) 201 and outputs (generates) an upscaled patch 204 which has been upscaled by the DL model. The upscaled patch 204 is an estimate of the new high-resolution training patch (fourth training image, or new correct image) 203, and ideally the two should match. Here, since the new high-resolution training patch 203 has different sharpness in each region, the generated upscaled patch 204 is also an image with different sharpness in each region. Specifically, an upscaled patch with a blurred effect similar to the interpolated training patch 202 is generated for the portion corresponding to the high-luminance region of the low-resolution training patch 201, and an upscaled patch with a sharp effect similar to the high-resolution training patch 200 is generated for the other regions.

Information on an imaging condition or a development condition may be input into the DL model together with the low-resolution training patch 201. For example, an image with a pixel value of the ISO sensitivity of the low-resolution training patch 201 may be concatenated in the depth (channel) direction to be input into the DL model. This allows upscaling according to the imaging condition or the development condition of the low-resolution training patch 201.

Subsequently, in step S105, the training unit 101d updates the weight of the DL model based on the error (loss) between the new high-resolution training patch (fourth training image, or new correct image) 203 and the upscaled patch 204 as an estimated result. Here, the weight includes the filter and bias of each layer of the convolutional neural network. In this embodiment, the weight is updated using, but not limited to, the Backpropagation. In mini-batch training, the weight is updated by determining the error between the new high-resolution training patch and the corresponding upscaled patch. As the Loss function for evaluation the error, for example, L2 norm or L1 norm can be used. The method of updating the weight (training method) is not limited to mini-batch learning, but can be either batch learning or online learning.

Subsequently, in step S106, the training unit 101d determines whether learning is terminated or not. The termination of the learning can be determined by whether the number of iterations of learning (updating the weight) has reached a predetermined value, or whether the change in weight at the time of updating is smaller than a predetermined value. If it is determined that learning is not terminated, the process returns to step S101 to acquire a plurality of new low-resolution training patches (first training images) 201 and the corresponding high-resolution training patches (correct images) 200. On the other hand, if it is determined that learning of the weight is terminated, the weight information is stored in the memory unit 101a. In this way, the training unit 101d trains the machine learning model based on the first training image and the fourth training image.

In this embodiment, the configuration of the convolutional neural network illustrated in FIG. 1 is used as the DL model, but is not limited to it. CN in FIG. 1 represents a convolutional layer. In the CN, the sum of the input, the convolution of the filter, and the bias is calculated and the result is transformed nonlinearly by the activation function. Initial values of each component of the filter and the bias are arbitrary and are determined by random numbers in this embodiment. The activation function can be, for example, a ReLU (Rectified Linear Unit) or a sigmoid function. The multidimensional array output at each layer except the final layer is a feature map. Generally, the feature map is a 4-dimensional array and has batch, vertical, horizontal, and channel dimensions. A skip connection 205 combines feature maps output from non-contiguous layers. The feature maps may be element-wise summed or concatenated in the channel direction (concatenation). In this embodiment, element-wise addition (element by element summation) is employed.

An element (block or module) in the dotted box in FIG. 1 represents a residual block. A network with multiple layers of residual blocks is called a residual network, and is widely used in image processing by DL.

However, this embodiment is not limited to this, and other elements may be multi-layered to form a network. For example, the Inception Module can be used, in which convolutional layers with different convolutional filter sizes are juxtaposed with each other and the resulting multiple feature maps are integrated to form a final feature map. Alternatively, the Dense Block with densely skipped connections may be used.

The processing load (convolution operation) may be reduced by reducing the size of the feature map in the intermediate layer by down sampling the feature map in the layer close to the input and enlarging the feature map in the layer close to the output. Here, the pooling, the stride, etc. can be used to down sample the feature map. The deconvolution or the transposed convolution, the pixel shuffle, the interpolation, etc. can be used to enlarge the feature map.

The low-resolution feature map is enlarged at a layer closer to the output to create a high-resolution feature map. In this embodiment, the pixel shuffle (PS) is used as the method for up sampling the feature map, but it is not limited to this.

Next, referring to FIG. 5, the estimation (DL upscaling) performed by the image estimation apparatus 103 in this embodiment will be described. FIG. 5 is a flowchart of generating the upscaled image from the low-resolution image using the DL model. Each step in FIG. 5 is mainly executed by the image acquisition unit 103b or the image processing unit 103c of the image estimation apparatus 103.

First, in step S201, the image acquisition unit 103b acquires a captured image. The captured image is a low-resolution image similarly to an image for learning. In this embodiment, it is transmitted from the image pickup apparatus 102, but this disclosure is not limited to this. For example, the captured image stored in memory unit 103a may be used.

Subsequently, in step S202, the image processing unit 103c generates an upscaled image for the captured image using the DL model. A convolutional neural network similar to the configuration illustrated in FIG. 1 is used to generate the upscaled image. In this embodiment, the captured image is input to the DL model and the upscaled image is output, but the imaging condition and the development condition may be input to the DL model along with the captured image using the method described in step S104. The weight information of the DL model is transmitted from the training apparatus 101 and stored in the memory unit 103a. When inputting the captured image into the DL model, it is not necessary to decompose the captured image into patches where each patch size is the same as the low-resolution training patch used during learning, but it is possible to process the image after decomposing it into multiple patches that overlap each other. In this case, the patches obtained after processing can be combined to form the upscaled image.

In this embodiment, the training apparatus 101 and the image estimation apparatus 103 are described as separate apparatuses, but this disclosure is not limited to this. Alternatively, the training apparatus 101 and the image estimation apparatus 103 may be integrated. That is, learning (the process illustrated in FIG. 4) and the estimation (the process illustrated in FIG. 5) may be performed in a single apparatus. According to the above configuration, this embodiment can provide a training method of learning (training) the machine learning model to perform upscaling with different sharpness for each region of an image. In addition, according to this embodiment, it is possible to provide an image processing method of upscaling with different sharpness for each region of an image using the machine learning model.

### Second Embodiment

Next, an image processing system in a second embodiment of this disclosure will be described. In this embodiment, the image processing system is also made to perform image processing to generate an upscaled image with different sharpness for each region from a low-resolution image using the DL model obtained through learning. This embodiment differs from the first embodiment in that the image pickup apparatus acquires the captured image (low-resolution image) and performs the image processing.

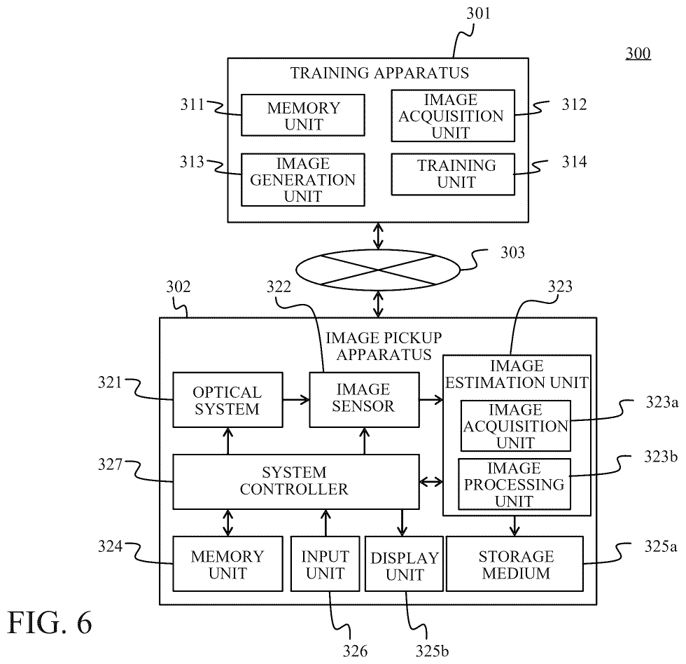

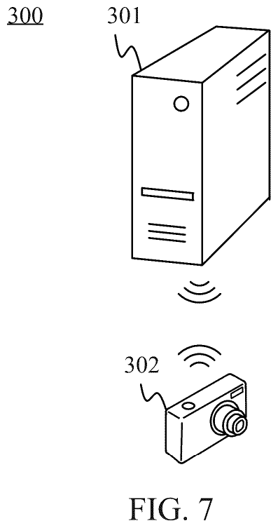

FIG. 6 is a block diagram of an image processing system 300 in this embodiment. FIG. 7 is an external view of the image processing system 300. The image processing system 300 includes a training apparatus 301 and an image pickup apparatus 302 that are connected via a network 303. The training apparatus 301 corresponds to a first apparatus and the image pickup apparatus 302 corresponds to a second apparatus. The training apparatus 301 and the image pickup apparatus 302 need not always be connected via the network 303.

The training apparatus 301 includes a memory unit 311, an image acquisition unit 312, an image generation unit (first image generation unit and second image generation unit) 313, and a training unit 314. These are used to learn the weight of the DL model in order to perform image processing to generate the upscaled image with different sharpness for each region from the low-resolution image. The image pickup apparatus 302 captures an image of an object space to acquire a captured image (low-resolution image) to generate an upscaled image of the captured image. Details about image processing performed by the image pickup apparatus 302 will be described below. The image pickup apparatus 302 includes an optical system 321 and an image sensor 322. An image estimation unit 323 includes an image acquisition unit 323a and an image processing unit 323b.

Of the learning of the weight of the DL model performed in the training apparatus 301, the only differences from the flowchart relating to learning the weight illustrated in FIG. 4 in the first embodiment are steps S103 and S104, and therefore only these points will be described below.

In this embodiment, in step S103, the image generation unit 313 generates a new high-resolution training patch (fourth training image, or new correct image) with different sharpness for each region from the high-resolution training patch (second training image) and the interpolated training patch (third training image). In this embodiment, the new high-resolution training patch is generated by replacing the region of the high-resolution training patch that corresponds to a high-intensity edge region (e.g., a second region having a luminance change rate which is equal to or larger than a predetermined rate) of the low-resolution training patch (first training image) with the interpolated training patch. The determination of the intensity of the edge region of the low-resolution training patch is made by comparing a threshold value with an edge intensity. For example, the edge intensity can be calculated by a differential (luminance value gradient) filter such as a Laplacian filter. Instead of replacing a part of the high-resolution training patch with the interpolated training patch, a new high-resolution training patch may be generated by weighted averaging of the two.

In this embodiment, the new high-resolution training patch is generated based on the portion of the low-resolution training patch corresponding to the high-intensity edge region, based on the high-resolution training patch and the interpolated training patch, but is not limited to this. Other methods will be described in another embodiment.

Subsequently, in step S104, the training unit 314 inputs the low-resolution training patch (first training image) and outputs (generates) the upscaled patch by the DL model. The upscaled patch is an estimation of the new high-resolution training patch (fourth training image, or new correct image), and ideally, the two should match. Since the sharpness of the new high-resolution training patch differs from region to region, the generated upscaled patch is also an image with different sharpness in each region. Specifically, the upscaled patch is generated such that the portion corresponding to the high-intensity edge region of the low-resolution training patch has a blurred effect similar to that of the interpolated training patch, and another portion has a sharp effect similar to that of the high-resolution training patch.

Next, details about the image processing performed by the image pickup apparatus 302 will be described.

The weight information of the DL model is learned in advance by the training apparatus 301 and stored in the memory unit 311. The image pickup apparatus 302 reads (or loads) the weight information from the memory unit 311 via the network 303 and stores it in the memory unit 324. The image estimation unit 323 uses the weight information of the DL model stored in the memory unit 324 and the captured image acquired by the image acquisition unit 323a to generate an image by upscaling the captured image in the image processing unit 323b. The generated upscaled image is stored in a storage medium 325a. When the user gives an instruction for displaying the upscaled image via an input unit 326, the stored image is read out and displayed on a display unit 325b. The captured image or its image information stored in the storage medium 325a may be read out and upscaled by the image estimation unit 323. The above series of control is performed by a system controller 327.

Next, the upscaled image processing using the DL model performed by the image estimation unit 323 in this embodiment will be described. Each step of the image processing is mainly executed by the image acquisition unit 323a or the image processing unit (estimation unit) 323b of the image estimation unit 323.

First, in step S201, the image acquisition unit 323a acquires the captured image (low-resolution image). In this embodiment, the captured image is acquired by the image pickup apparatus 302 and stored in the memory unit 324, but this disclosure is not limited to this.

Subsequently, in step S202, the image processing unit 323b generates an upscaled image from the captured image using the DL model. A convolutional neural network similar to the configuration illustrated in FIG. 1 is used to generate the upscaled image.

In this embodiment, the captured image is input to the DL model and the upscaled image is output, but the imaging condition or the development condition may be input to the DL model together with the captured image using the method described in step S104. The weight information of the DL model is transmitted from the training apparatus 301 and stored in the memory unit 324. When inputting the captured image into the DL model, it is not necessary to decompose the captured image into patches where each patch size is the same as the low-resolution training patch used during learning, but it is possible to process the image after decomposing it into multiple patches that overlap each other. In this case, the patches obtained after processing can be combined to form the upscaled image.

According to the above configuration, this embodiment can provide a training method of learning (training) the machine learning model to perform upscaling with different sharpness for each region of an image. In addition, according to this embodiment, it is possible to provide an image processing method of upscaling with different sharpness for each region of an image using the machine learning model.

### Third Embodiment

Next, an image processing system in a third embodiment of this disclosure will be described. In this embodiment, the image processing system is also made to perform image processing to generate an upscaled image with different sharpness for each region from a low-resolution image using a DL model obtained by learning. This embodiment differs from the first and second embodiments in that it has a processing apparatus (computer) that transmits a captured image (low-resolution image) that is a target of image processing to the image estimation apparatus and receives a processed output image (upscaled image) from the image estimation apparatus.

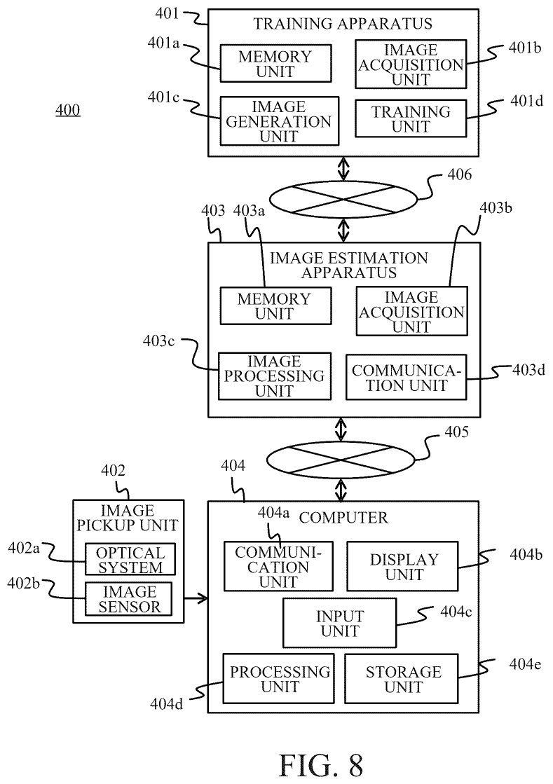

FIG. 8 is a block diagram of an image processing system 400 in this embodiment. The image processing system 400 includes a training apparatus 401, an image pickup apparatus 402, an image estimation apparatus 403, and a processing unit (computer) 404. The training apparatus 401 and the image estimation apparatus 403 are, for example, servers. The computer 404 is, for example, a user terminal (personal computer, smartphone, or camera). The computer 404 is connected to an image estimation apparatus 403 via a network 405. The image estimation apparatus 403 is connected to the training apparatus 401 via a network 406.

That is, the computer 404 and the image estimation apparatus 403 are configured to be communicable, and the image estimation apparatus 403 and the training apparatus 401 are configured to be communicable. The training apparatus 401 corresponds to a third apparatus, the computer 404 corresponds to a fourth apparatus, and the image estimation apparatus 403 corresponds to a fifth apparatus.

The configuration of the training apparatus 401 is similar to that of the training apparatus 101 in the first embodiment, and therefore a description thereof will be omitted. The configuration of the image pickup apparatus 402 is similar to that of the image pickup apparatus 102 in the first embodiment, and therefore a description thereof will be omitted.

The image estimation apparatus 403 includes a memory unit 403a, an image acquisition unit 403b, an image processing unit (estimation unit) 403c, and a communication unit (reception unit) 403d. The memory unit 403a, the image acquisition unit 403b, and the image processing unit 403c are respectively similar to the memory unit 103a, the image acquisition unit 103b, and the image processing unit 103c of the image estimation apparatus 103 in the first embodiment. The communication unit 403d has a function of receiving a request transmitted from the computer 404 and a function of transmitting an output image (upscaled image) generated by the image estimation apparatus 403 to the computer 404.

The computer 404 includes a communication unit (transmission unit) 404a, a display unit 404b, an input unit 404c, a processing unit 404d, and a storage unit 404e. The communication unit 404a has a function of transmitting a request to the image estimation apparatus 403 to cause the image estimation apparatus 403 to perform processing on the captured image (low resolution image), and a function of receiving the output image (upscaled image) processed by the image estimation apparatus 403. The display unit 404b has a function of displaying various information. The information displayed by the display unit 404b includes, for example, the captured image (low-resolution image) to be transmitted to the image estimation apparatus 403 and the output image (upscaled image) received from the image estimation apparatus 403. The input unit 404c inputs (receives) an instruction from the user to start image processing, etc. The processing unit 404d has a function of performing image processing including noise reduction and sharpness on the output image (upscaled image) received from the image estimation apparatus 403. The storage unit 404e stores the captured image acquired from the image pickup apparatus 402, the output image received from the image estimation apparatus 403, etc.

Of the weight learning of the DL model executed by the training apparatus 401, the only differences from the flowchart relating to the weight learning illustrated in FIG. 4 of the first embodiment are steps S103 and S104, and therefore only these points will be described below.

In this embodiment, in step S103, the image generation unit 401c generates a new high-resolution training patch (fourth training image, or new correct image) with different sharpness for each region from a high-resolution training patch (second training image) and an interpolated training patch (third training image). In this embodiment, the new high-resolution training patch is generated by replacing the portion of the high-resolution training patch corresponding to the high-luminance region and the high-intensity edge region of the low-resolution training patch (first training image) with the interpolated training patch. The determination of the high-luminance region and the high-intensity edge region of the low-resolution training patch is performed in the same way as in the first and second embodiments.

Subsequently, in step S104, the training unit 401d inputs the low-resolution training patch (first training image) and outputs (generates) an upscaled patch by the DL model. The upscaled patch is an estimation of the new high-resolution training patch (fourth training image, or new correct image), and ideally, the two should match. Since the sharpness of the new high-resolution training patch differs from region to region, the generated upscaled patch is also an image with different sharpness in each region. Specifically, an upscaled patch is generated such that the portion corresponding to the high-luminance region and the high-intensity edge region of the low-resolution training patch has a blurred effect similar to that of the interpolated training patch, while the other portions have a sharp effect similar to that of the high-resolution training patch.

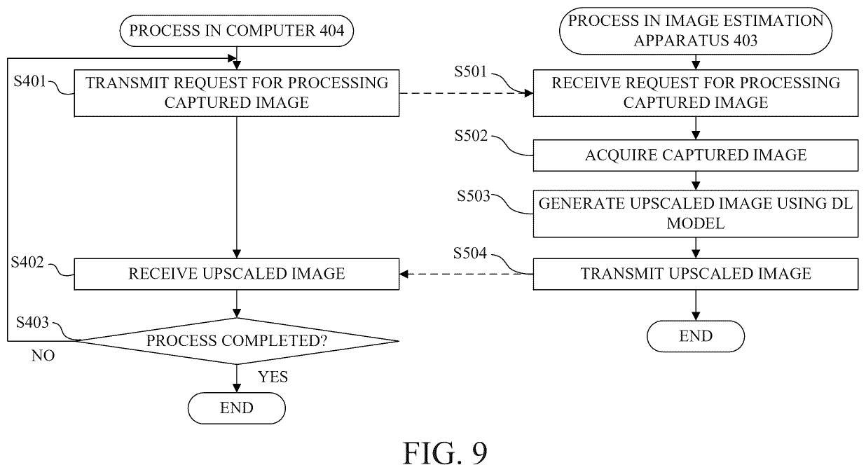

Next, the image processing in this embodiment will be described. The image processing illustrated in FIG. 9 starts when the user gives the instruction to start the image processing via the computer 404. First, the operation of the computer 404 will be described.

First, in step S401, the computer 404 transmits a request for processing the captured image (low-resolution image) to the image estimation apparatus 403. The captured image to be processed and its image information may be transmitted to the image estimation apparatus 403 by any method. For example, the captured image and the image information may be uploaded to the image estimation apparatus 403 at the same time as step S401, or it may be uploaded to the image estimation apparatus 403 before step S401. The captured image may also be an image stored on a server different from the image estimation apparatus 403. In step S401, the computer 404 may transmit an ID to authenticate the user together with a request for processing the captured image.

Subsequently, in step S402, the computer 404 receives the output image (upscaled image) generated in the image estimation apparatus 403.

Next, the operation of the image estimation apparatus 403 will be described.

First, in step S501, the image estimation apparatus 403 receives a request for processing the captured image (low-resolution image) transmitted from the computer 404. The image estimation apparatus 403 determines that it has been instructed to process the captured image, and executes the processes in and after step S502.

Subsequently, in step S502, the image acquisition unit 403b acquires the captured image. In this embodiment, the captured image is transmitted from the computer 404. Along with the captured image, its imaging condition or development condition may also be acquired to be used in the steps described below.

Subsequently, in step S503, the image processing unit 403c uses the DL model to generate an upscaled image of the captured image with different sharpness for each region. In this embodiment, the captured image is input to the DL model to output the upscaled image, but the imaging condition or the development condition of the captured image may be input to the DL model together with the captured image using the method described in step S104.

Subsequently, in step S504, the image estimation apparatus 403 sends the output image (upscaled image) to the computer 404.

In the above configuration, according to this embodiment, it is possible to provide a training method for training a machine learning model to perform upscaling with different sharpness for each region of an image. Further, according to this embodiment, it is possible to provide an image processing method for upscaling with different sharpness for each region of an image using the machine learning model.

### OTHER EMBODIMENTS

Embodiment(s) of the disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read-only memory (ROM), a storage of distributed computing systems, an optical disc (such as a compact disc (CD), digital versatile disc (DVD), or Blu-ray Disc (BD)™), a flash memory device, a memory card, and the like.

While the disclosure has described example embodiments, it is to be understood that some embodiments are not limited to the disclosed embodiments. The scope of the following claims is to be accorded the broadest interpretation so as to encompass all such modifications and equivalent structures and functions.

According to this disclosure, it is possible to provide a training method for training a machine learning model for upscaling with different sharpness for each region of an image.

This application claims priority to Japanese Patent Application No. 2023-209778, which was filed on Dec. 13, 2023, and which is hereby incorporated by reference herein in its entirety.

What is claimed is:

1. A training method comprising the steps of:
acquiring a first training image and a second training image corresponding to the first training image, having a higher resolution than the first training image;
generating a third training image by enlarging the first training image by interpolation;
generating a fourth training image with different sharpness for each region based on the second training image, the third training image, and at least one of a first region and a second region in the first training image, the first region having a luminance value which is equal to or larger than a predetermined value and the second region having a luminance change rate which is equal to or larger than a predetermined rate; and
training a machine learning model based on the first training image and the fourth training image.

2. The training method according to claim 1, wherein the second training image has more pixels than the first training image and includes a same object in a same scene as the first training image.

3. The training method according to claim 1, wherein the third training image has a same number of pixels as the second training image and is more blurred than the second training image.

4. The training method according to claim 1, wherein the fourth training image is generated by replacing a portion of the second training image with a corresponding portion of the third training image.

5. The training method according to claim 1, wherein the fourth training image is generated by weighted averaging a portion of the second training image with a corresponding portion of the third training image.

6. The training method according to claim 1, wherein the fourth training image includes a region corresponding to at least one of the high-luminance region and the edge region of the first training image and differing in sharpness from another region.

7. A training apparatus comprising:
an image acquisition unit configured to acquire a first training image and a second training image corresponding to the first training image, having a higher resolution than the first training image;
a first image generation unit configured to generate a third training image by enlarging the first training image by interpolation;
a second image generation unit configured to generate a fourth training image with different sharpness for each region based on the second training image, the third training image, and at least one of a first region and a second region in the first training image, the first region having a luminance value which is equal to or larger than a predetermined value and the second region having a luminance change rate which is equal to or larger than a predetermined rate; and
a training unit configured to train a machine learning model based on the first training image and the fourth training image.

8. A non-transitory computer-readable storage medium storing a program that causes a computer to execute the training method according to claim 1.

9. An image processing method comprising the steps of:
acquiring a captured image; and
performing upscaling with different sharpness for each region of the captured image using the machine learning model obtained by the training method according to claim 1.

10. A non-transitory computer-readable storage medium storing a program that causes a computer to execute the image processing method according to claim 9.

11. A method of generating a learned model comprising the steps of:
acquiring a first training image and a second training image corresponding to the first training image, having a higher resolution than the first training image;
generating a third training image by enlarging the first training image by interpolation;
generating a fourth training image with different sharpness for each region based on the second training image, the third training image, and at least one of a first region and a second region in the first training image, the first region having a luminance value which is equal to or larger than a predetermined value and the second region having a luminance change rate which is equal to or larger than a predetermined rate; and
training a machine learning model based on the first training image and the fourth training image.
